(19) United States
(12) Patent Application Publication
(10) Pub. No.: US 2019/0079362 A1
(43) Pub. Date: Mar. 14, 2019

(54) DISPLAY PANEL AND REPAIR METHOD THEREOF

(71) Applicant: HKC Corporation Limited, Shenzhen City, Guangdong (CN)

(72) Inventor: Huailiang HE, Shenzhen City, Guangdong (CN)

(21) Appl. No.: 15/738,732

(22) PCT Filed: Oct. 20, 2017
(86) PCT No.: PCT/CN2017/107034

§ 371 Date: Dec. 21, 2017

(30) Foreign Application Priority Data
Sep. 14, 2017 (CN) 201710827343.9

(51) Int. Cl. G02F 1/1362; G02F 1/13; G09G 3/36

(52) U.S. Cl. CPC G02F 1/136259; G09G 3/3677; G02F 1/1309

(57) ABSTRACT

A display device comprises: a control unit; a display panel, including a display area and a wiring area; a plurality of gate driving chips, located in the wiring area, and coupled to a plurality of scan lines; a plurality of source driving chips, located in the wiring area, and coupled to a plurality of data lines; at least one repair module, located in the wiring area of the display panel, the repair module including: a plurality of operational amplifiers; a repair line, connected to the control unit and the operational amplifiers, wherein there is an overlap region in the repair lines, the scan lines, and the data lines; wherein, the control unit is coupled to the gate driving chip and the source driving chip, and provides a repair signal, and the repair signal is amplified by the operational amplifiers and transmitted through the repair line.

### BACKGROUND OF THE INVENTION

### Field of Invention

The present invention generally relates to a display technology, and especially relates to a display device and repair method thereof.

### Description of Related Art

Thin film transistor liquid crystal display (TFT-LCD) is one main stream of the current flat panel displays, and has become an important display medium in current information technology (IT) products and video products. A driving principle of the thin film transistor liquid crystal display (TFT-LCD) is that R/G/B compression signals, controlling signals and an energy are electrically coupled to a connector of a printed circuit board (PCB) through wiring lines on a system main board, and data information is processed by a timing controller (TCON) of the printed circuit board (PCB) and then connected with a display area through a source driving chip on film (S-COF) and a gate driving chip on film (G-COF), so that the thin film transistor liquid crystal display (TFT-LCD) can get a required power and signals.

In practical application, some defects in a manufacturing process could cause a breakpoint on a data line or a scan line. Current repair method is to provide a repair line outside the display area for transmitting data over the breakpoint. However, the transmission route through the repair line is longer than originally predetermined routes (other routes without the breakpoint), and therefore has a higher impedance. To avoid the final voltage at the breakpoint being lower than the target voltage due to the effect of a high resistance and a high capacitance through the repair line, the data line needs to be connected to the PCB, and a larger operational amplifier (OP) is added on the PCB to increase output push capability for the repair line.

### SUMMARY OF THE INVENTION

For resolving the technical problems above-mentioned, the objects of the present invention are to provide a display device and repair method thereof.

The objects and technical solutions of the present invention can be further implemented by following technical configuration and means. In one perspective, the present invention provides a display device. The display device comprises: a control unit; a display panel, including a display area and a wiring area; a plurality of gate driving chips, located in the wiring area of the display panel, and coupled to a plurality of scan lines; a plurality of source driving chips, located in the wiring area of the display panel, and coupled to a plurality of data lines; at least one repair module, located in the wiring area of the display panel. The repair module includes: a plurality of operational amplifiers; a repair line, connected to the control unit and the operational amplifiers, wherein there is an overlap region in the repair lines, the scan lines, and the data lines; wherein, the control unit is coupled to the gate driving chip and the source driving chip, and provides a repair signal, and the repair signal is amplified by the operational amplifiers and transmitted through the repair line.

In one embodiment of the present invention, the operational amplifiers are located correspondingly in the source driving chip.

In one embodiment of the present invention, the operational amplifiers are located on the display panel, wherein the operational amplifiers are located between the gate driving chips, or located between the source driving chips.

In one embodiment of the present invention, the operational amplifiers are connected in series, wherein an output end of the former operational amplifier is coupled to an input end of the next operational amplifier.

In one embodiment of the present invention, the operational amplifiers are individually connected to the repair line in cascade, to make a transmission of the repair signal through the repair line and the operational amplifiers to be a transmission without attenuation.

The objects and technical solutions of the present invention can be further implemented by following technical configuration and means.

Another object of the present invention is to provide a repair method of the display device, which comprises: when a breakpoint located on the scan line or on the data line of the display device, the breakpoint separating the scan line or the data line into a first portion and a second portion; connecting the overlap region of the repair line and the scan line wherein the breakpoint is located, or connecting the overlap region of the repair line and the data line wherein the breakpoint is located; and the control unit generating the repair signal which is generated by the gate driving chip or the source driving chip, the repair signal transmitted through the repair line and the operational amplifiers, to the first portion and the second portion; wherein a transmission of the repair signal through the repair line, the operational amplifiers, and the second portion, is a transmission without attenuation.

In one embodiment of the present invention, the operational amplifiers are located correspondingly in the source driving chip.

In one embodiment of the present invention, the operational amplifiers are located between the gate driving chips, or located between the source driving chips.

In one embodiment of the present invention, the operational amplifiers are connected in series, wherein an output end of the former operational amplifier is coupled to an input end of the next operational amplifier.

Another object of the present invention is to provide a display device, which comprises: a control unit; a display panel, including a display area and a wiring area; a plurality of gate driving chips, located in the wiring area of the display panel, and coupled to a plurality of scan lines; a plurality of source driving chips, located in the wiring area of the display panel, and coupled to a plurality of data lines; at least one repair module, located in the wiring area of the display panel, the repair module including: a plurality of operational amplifiers; a repair line, connected to the control unit and the operational amplifiers, wherein there is an overlap region in the repair lines, the scan lines, and the data lines; wherein, the control unit is coupled to the gate driving chip and the source driving chip, and provides a repair signal, and the repair signal is amplified by the operational amplifiers and transmitted through the repair line; wherein, the operational amplifiers are connected in series, and an output end of the former operational amplifier is coupled to an input end of the next operational amplifier, and the operational amplifiers are individually connected to the repair line in cascade, to make a transmission of the repair signal through the repair line and the operational amplifiers to be a transmission without attenuation.

The present invention provides a plurality of operational amplifiers with low driving capability disposed in the source driving chip or in the wiring area of the display panel, to replace conventional operational amplifiers mounted outside. It can optimize a circuit design of the repair module of the display device, and obtain a cost reduction of extra components and their mounting processes, to reduce the manufacturing cost of the display device.

### BRIEF DESCRIPTION OF THE DRAWINGS

FIG. 1 illustrates a repair method of an exemplary display device.

FIG. 2 illustrates a repair method of the display device according to one embodiment of the present invention.

FIG. 3 illustrates a partial view of a repair line and an operational amplifier therein.

FIG. 4 illustrates a repair method of the display device according to one embodiment of the present invention.

FIG. 5 illustrates a repair method of the display device according to one embodiment of the present invention.

FIG. 6 illustrates a repair method of the display device according to one embodiment of the present invention.

FIG. 7 illustrates an exemplary display device according to one embodiment of the present invention.

### DESCRIPTION OF THE PREFERRED EMBODIMENTS

The drawings as referred to following embodiments throughout the description of the present invention are examples for implementing the objects of the present invention. The orientation words or terms used in the description of the present invention, such as “above”, “under”, “forward”, “backward”, “left”, “right”, “inner”, “outer”, and “side”. are examples in the drawings for illustrative purpose only, or just show the interrelations between the components, but not to be construed as limitations to the scope of the present invention.

The drawings and the description of the present invention are deemed to be examples but not limitations essentially. In the drawings, components or elements having similar or same structure are marked with the same numbers. In addition, sizes and thicknesses of every component or element are just examples, but not drawn according to the actual scale and not read as limitations to the scope of the present invention.

In drawings of the present invention, sizes and thicknesses of layers, films, panels, or regions are emphasized for clearness, easy to describe and easy to understand. Therefore, some layers, films, or regions are emphasized but not drawn according to their actual scales. It is to be understood that, for example, when one of the components of layers, films, regions, or substrate are “on” another component of layers, films, regions, or substrate, the one of the components of layers, films, regions, or substrate could be adjacent on another component of layers, films, regions, or substrate directly, or there could be other inter-components of layers, films, regions, or substrate set therebetween.

Furthermore, in the description of the present invention, a word “comprising” or “including” is construed to comprise or include the related components, but not exclude other components, except there is clearly opposite word or description in the present invention. And, in the description of the present invention, a word “on” can be construed to be above or under a target component, but not only construed to be on a top of the target component in vertical or gravity direction.

For further clarifying the technical solutions or functions of the present invention to implement the objects of the present invention, a display device and a repair method thereof, and their specific implementations, structures, features and functions, according to a preferred embodiment of the present invention will be apparent from the following detailed description, which proceeds with reference to the accompanying drawings.

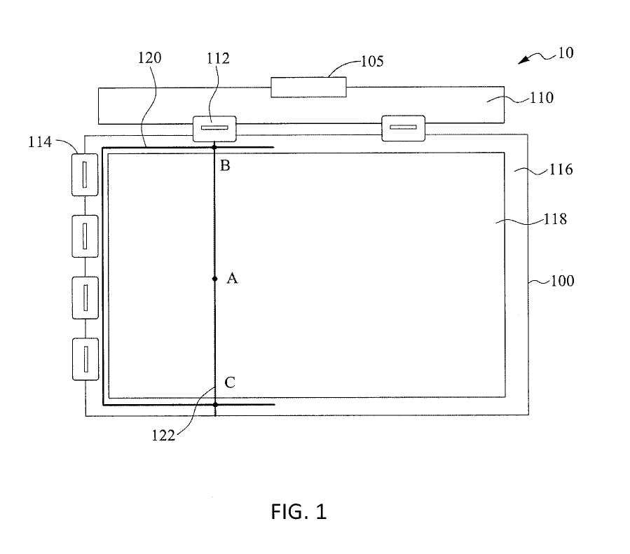

FIG. 1 illustrates a repair method of a display device. A repair method of an exemplary display device according to the present invention comprises: a printed circuit board 110, including a control unit 105; a display panel 100, including a display area 118 and a wiring area 116; a plurality of source driving chips 112 and a plurality of gate driving chips 114; and a repair line 120, encircling the wiring area 116 of the display panel 100. When there is a breakpoint A on the data line 122, a display function corresponding to the data line 122 from point A through point C does not work. In order to solve the aforementioned problem, it is to connect two overlap regions B and C of the data line 122 and the repair line 120, by a laser or a laser induced chemical vapor deposition. Accordingly, the data transmitted on the data line between points A and B, follow the original transmission data line layout design; the data transmitted on the data line between points A and C, pass through an auxiliary line of the repair line, which forms a data transmission route B-C-A. However, this data transmission route B-C-A is much longer than other data lines without the breakpoint, and therefore has a higher impedance (including a resistance and a capacitance through the data transmission route B-C-A). The operational amplifier with high drive capability can be located on the PCB for avoiding distortion of the transmitted data.

According to the present invention, some embodiments of a plurality of data lines with the breakpoints can be reasoned by the aforementioned embodiment of the single data line with the breakpoint. That is, the data lines with the breakpoints respectively need a plurality of repair modules (including the operational amplifiers and the repair lines) for repair purpose. Therefore, the embodiment of the repair method the single data line with the breakpoint, is for example, but not to limit the number of the data lines with the breakpoints by the repair method.

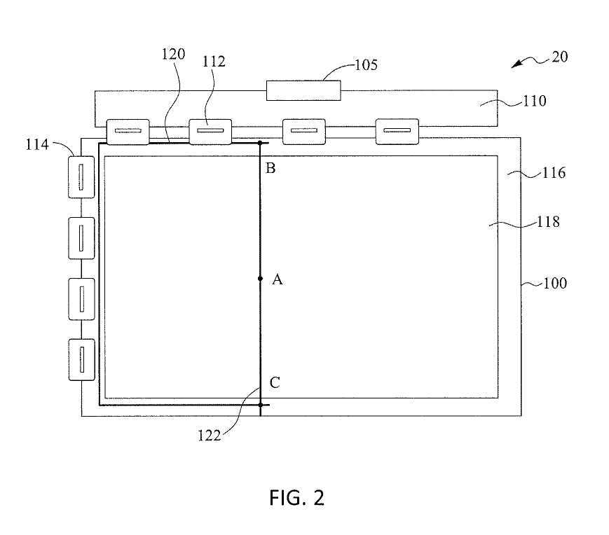

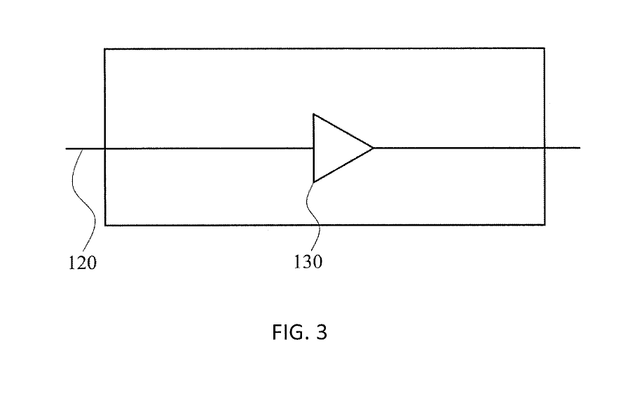

FIG. 2 illustrates a repair method of the display device according to one embodiment of the present invention, and FIG. 3 illustrates a partial view of a repair line and an operational amplifier according to one embodiment of the present invention. Please refer to FIGS. 2 and 3, wherein a display device 20 according to one embodiment of the present invention comprises: a printed circuit board 110, including a control unit 105; a display panel 100, including a display area 118 and a wiring area 116; a plurality of gate driving chips 114, located in the wiring area 116 of the display panel 100, and coupled to a plurality of scan lines (not shown); a plurality of source driving chips 112, located in the wiring area 116 of the display panel 100, and coupled to a plurality of data lines 122; at least one repair module disposed in the wiring area 116 of the display panel 100. The repair module includes: a plurality of operational amplifiers 130; and a repair line 120, connected to the control unit 105 and the operational amplifiers 130. There is an overlap region in the repair lines 120, the scan lines, and the data lines 122; for example, the overlap region can be but not limited to an intersection point of the repair line 120 and the data line 122 in FIG. 2. The control unit 105 is coupled to the gate driving chip 114 and the source driving chip 112, and provides a repair signal, and the repair signal is amplified by the operational amplifiers and transmitted through the repair line.

In one embodiment of the present invention, the operational amplifiers 130 are located correspondingly in the source driving chip 122.

In one embodiment of the present invention, the operational amplifiers 130 are connected in series, and an output end of the former operational amplifier 130 is coupled to an input end of the next operational amplifier 130.

In some embodiments of the present invention, the operational amplifiers are individually connected to the repair line in cascade, to make a transmission of the repair signal through the repair line and the operational amplifiers to be a transmission without attenuation.

Please refer to FIGS. 2 and 3 again, wherein a repair method of the display device 20 is illustrated according to one embodiment of the present invention. The repair method comprises: when the breakpoint A located on the data line 122 of the display device 20, the breakpoint A separating the data line into a first portion BA and a second portion AC, wherein the first portion BA is coupled to the source driving chip 112, and the second portion CA is far and separated from the source driving chip 112; connecting two overlap regions B and C of the data line 122 and the repair line 120, by a physical or chemical method (for example, a laser or a laser induced chemical vapor deposition); the control unit 105 on the PCB generating the repair signal, and the repair signal transmitted from the source driving chip, through the repair line 120 and the operational amplifiers 130, to the first portion BA and the second portion CA of the data line. A transmission of the repair signal through the repair line 120, the operational amplifiers 130, and the second portion CA, is a transmission without attenuation, wherein the transmission route is from the last source driving chip 112, through the overlap region C, to the breakpoint A.

In some embodiments of the present invention, the operational amplifiers 130 can be a plurality of operational amplifiers with low driving capability. The repair signal is transmitted through the operational amplifiers connected in series, to the second portion CA of the data line 122.

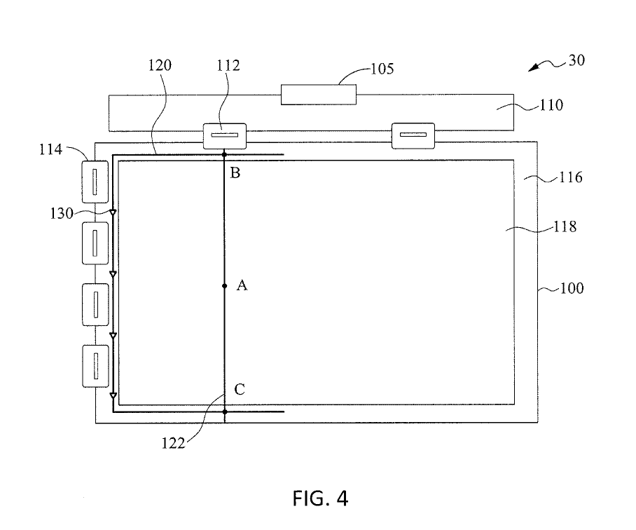

FIG. 4 illustrates one embodiment of a display device and repair method thereof. As shown in FIGS. 3 and 4, in comparison with the display device 20, the display device 30 further comprises: a plurality of operational amplifiers 130, located in the wiring area of the display panel. In FIG. 4, the operational amplifiers are located between the gate driving chips 114. However, the operational amplifiers can be not limited to the locations between the gate driving chips 114; for example, the operational amplifiers can be locations between the source driving chips 112.

In one embodiment of the present invention, the repair method of the display device 30 comprises: transmitting repair signals outputted from the control unit 105 through the plurality of operational amplifiers 130 disposed on the display panel 100. Comparing with the display device 20, the plurality of operational amplifiers 130 of the display device 30 are disposed in the wiring area 116 of the display panel 100, rather than disposed in the source driving chip 112. The transmission route can be deemed from the output end of the last operational amplifier 130, through the overlap region C, to the breakpoint A. Since the above-mentioned transmission route is very short, the load of each operational amplifier 130 can be reduced to more effectively transmitting the repair signals.

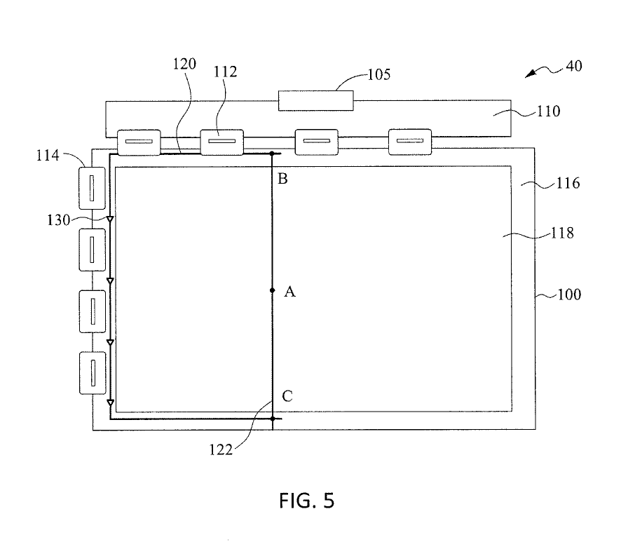

FIG. 5 illustrates a repair method of the display device according to one embodiment of the present invention. Please refer both FIGS. 5 and 3, comparing with the display device 20 and the display device 30, a display device 40 comprises a plurality of operational amplifiers 130 disposed in the wiring area 116 and the source driving chips 112 of the display panel 100.

In one embodiment of the present invention, the repair method of the display device 40 comprises: transmitting repair signals outputted from the control unit 105 through the plurality of operational amplifiers 130 disposed in the wiring area 116 and the source driving chips 112 of the display panel 100. Comparing with the display device 20 and the display device 30, the plurality of operational amplifiers 130 of the display device 40 are disposed in the wiring area 116 and the source driving chips 112 of the display panel 100, which is more complete and delicate than the plurality of operational amplifiers 130 of the display device 20 and the display device 30, so that the repair signals of the display device 40 can be more accurately transmitted. Besides, the adjustable range and the fault tolerance of the repair signals can be accordingly improved by transmission through the plurality of operational amplifiers 130.

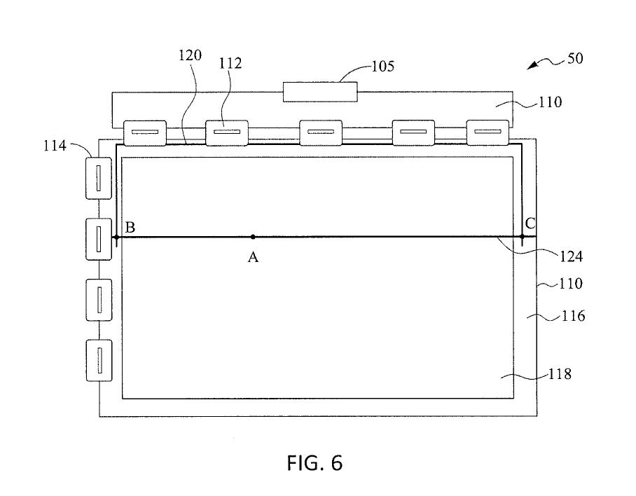

In above-mentioned embodiments of the present invention, the present display devices (20, 30, and 40) can be all used for repairing the breakpoint A in the data line 122. However, the operational amplifiers 130 and the repair line 120 of the present invention can also be used for repairing a breakpoint in the scan line. FIG. 6 illustrates a repair method of the display device according to one embodiment of the present invention. Please refer to FIGS. 6 and 3, a display device 50 comprises at least one repair module disposed in the wiring area of the display panel 100. The repair module comprises: a plurality of operational amplifiers 130; a repair line 120 for connecting a control unit 105 to the plurality of operational amplifiers 130, wherein an overlap region is disposed between the repair line 120 and the scan line 124, and wherein the plurality of operational amplifiers 130 are disposed in or between the source driving chips 112.

In one embodiment of the present invention, the repair method of the display device 50 comprises: when there is a breakpoint A on the scan line 124 of the display device 50, the breakpoint A separating the scan line into a first portion CA and a second portion BA, wherein the first portion CA connects to the gate driving chip 114, and the second portion BA is far away from the gate driving chip 114; connecting the overlap region (B, C) between the repair line 120 and the scan line 124 where the breakpoint is located, by using a laser welding process or a laser induced chemical vapor deposition process; and the control unit 105 generating the repair signals which are outputted from the gate driving chip 114 and transmitted through the repair line 120 and the operational amplifiers 130, to the first portion BA and the second portion CA of the scan line; wherein a transmission route of the repair signals through the repair line 120, the operational amplifiers 130, to the second portion CA of the scan line, is an equivalent transmission route of the output end of the repair signals through the last operational amplifier 130, the overlap region C, to the breakpoint A, so that the repair signals can be transmitted to the second portion CA of the scan line without attenuation.

In some embodiments of the present invention, if there are a plurality of disconnected lines (for example, a plurality of disconnected data lines or a plurality of disconnected scan lines) on the display panel, the present repair module on the display panel can be used for one-on-one repairing the plurality of disconnected lines to increase the display effect/capability of the display device.

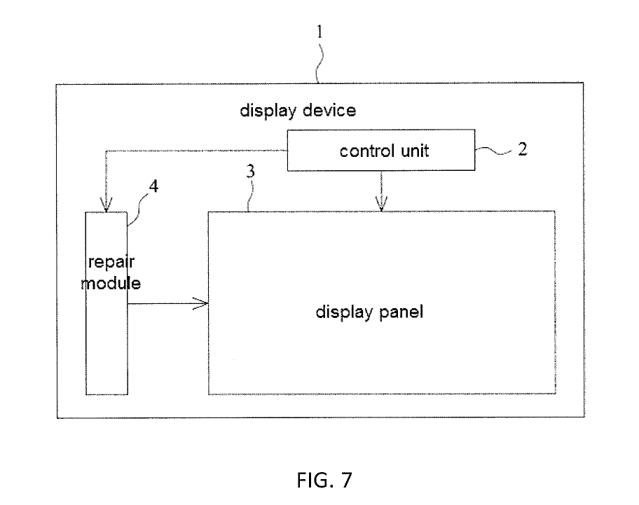

FIG. 7 illustrates an exemplary display device according to one embodiment of the present invention. In some embodiments of the present invention, a display device 1 comprises: a control unit 2, a display panel 3, and a repair module 4, wherein the repair module 4 is disposed in a wiring area outside of the display panel 3, or disposed in the source driving chips, wherein the repair module 4 can include all of the technical features of the display device (20, 30, 40, and 50) above-mentioned.

The present invention provides a plurality of operational amplifiers with low driving capability disposed in the source driving chips or in the wiring area of the display panel, to replace conventional operational amplifiers mounted outside. It can optimize a circuit design of the repair module of the display device, and obtain a cost reduction by saving extra components and their mounting processes, to reduce the manufacturing cost of the display device.

“In some embodiments of the present invention” and “In a variety of embodiments of the present invention” are used repeatedly through the description. They usually mean different embodiments. However, they can also mean the same embodiments. “Comprising”, “having” and “including” are synonyms, except it is noted to be different or has other meanings before and after its description.

The present invention has been described in considerable detail with reference to certain preferred embodiments thereof. It should be understood that the description is for illustrative purpose, not for limiting the scope of the present invention. Those skilled in this art can readily conceive simple or equivalent variations and modifications, which are still within the spirit of the present invention.

What is claimed is:

1. A display device, comprising:
a control unit;
a display panel, including a display area and a wiring area;
a plurality of gate driving chips, located in the wiring area of the display panel, and coupled to a plurality of scan lines;
a plurality of source driving chips, located in the wiring area of the display panel, and coupled to a plurality of data lines;
at least one repair module, located in the wiring area of the display panel, the repair module including:
a plurality of operational amplifiers;
a repair line, connected to the control unit and the operational amplifiers, wherein there is an overlap region in the repair lines, the scan lines, and the data lines;
wherein, the control unit is coupled to the gate driving chip and the source driving chip, and provides a repair signal, and the operational amplifiers amplify and transmit the repair signal transmitted through the repair line.

2. The display device of claim 1, wherein the operational amplifiers are located correspondingly in the source driving chip.

3. The display device of claim 1, wherein the operational amplifiers are located on the display panel.

4. The display device of claim 3, wherein the operational amplifiers are located between the gate driving chips.

5. The display device of claim 3, wherein the operational amplifiers are located between the source driving chips.

6. The display device of claim 3, wherein the operational amplifiers are located in the wiring area of the display panel.

7. The display device of claim 1, wherein the operational amplifiers are connected in series.

8. The display device of claim 7, wherein an output end of the former operational amplifier is coupled to an input end of the next operational amplifier.

9. The display device of claim 8, wherein the operational amplifiers are individually connected to the repair line in cascade.

10. The display device of claim 9, wherein a transmission of the repair signal through the repair line and the operational amplifiers, is a transmission without attenuation.

11. A repair method of the display device of claim 1, comprising:
when a breakpoint located on the scan line or data line of the display device, the breakpoint separating the scan line or data line into a first portion and a second portion;
connecting the overlap region of the repair line and the scan line wherein the breakpoint is located, or connecting the overlap region of the repair line and the data line wherein the breakpoint is located; and
the control unit generating the repair signal, and the repair signal transmitted through the repair line and the operational amplifiers to the first portion and the second portion;
wherein a transmission of the repair signal through the repair line, the operational amplifiers, and the second portion, is a transmission without attenuation.

12. The repair method of claim 11, wherein the operational amplifiers are located correspondingly in the source driving chip.

13. The repair method of claim 11, wherein the operational amplifiers are located on the display panel.

14. The repair method of claim 13, wherein the operational amplifiers are located between the gate driving chips.

15. The repair method of claim 13, wherein the operational amplifiers are located between the source driving chips.

16. The repair method of claim 13, wherein the operational amplifiers are located in the wiring area of the display panel.

17. The repair method of claim 11, wherein the operational amplifiers are connected in series.

18. The repair method of claim 17, wherein an output end of the former operational amplifier is coupled to an input end of the next operational amplifier.

19. The repair method of claim 18, wherein the operational amplifiers are individually connected to the repair line in cascade, to make a transmission of the repair signal through the repair line, the operational amplifiers, and the second portion, to be a transmission without attenuation.

20. A display device, comprising:
a control unit;
a display panel, including a display area and a wiring area;
a plurality of gate driving chips, located in the wiring area of the display panel, and coupled to a plurality of scan lines;
a plurality of source driving chips, located in the wiring area of the display panel, and coupled to a plurality of data lines;
at least one repair module, located in the wiring area of the display panel, the repair module including:
a plurality of operational amplifiers;
a repair line, connected to the control unit and the operational amplifiers, wherein there is an overlap region in the repair lines, the scan lines, and the data lines;
wherein, the control unit is coupled to the gate driving chip and the source driving chip, and provides a repair signal, and the operational amplifiers amplify and transmit the repair signal transmitted through the repair line;
wherein, the operational amplifiers are connected in series, and an output end of the former operational amplifier is coupled to an input end of the next operational amplifier, and the operational amplifiers are individually connected to the repair line in cascade, to make a transmission of the repair signal through the repair line and the operational amplifiers to be a transmission without attenuation.
